(19) United States
(12) Patent Application Publication
(10) Pub. No.: US 2018/0293622 A1
(43) Pub. Date: Oct. 11, 2018

(54) SYSTEM AND METHOD FOR AUTOMATIC DEVICE UPDATE WITH LIMITED NETWORK CONNECTIVITY

(71) Applicant: Samsung Electronics Co., Ltd., Suwon-si (KR)

(72) Inventors: David Tompkins, Arlington, TX (US); Naga Ramesh Chalapalli, Coppell, TX (US); Sundararajan Chellappan, Plano, TX (US); Ataur Khan, Irving, TX (US)

(21) Appl. No.: 15/948,830

(22) Filed: Apr. 9, 2018

Related U.S. Application Data
(60) Provisional application No. 62/483,865, filed on Apr. 10, 2017.

(51) Int. Cl. G06Q 30/02

(52) U.S. Cl. CPC G06Q 30/0264; G06Q 30/0259; G06Q 30/0281

(57) ABSTRACT

A method and apparatus for automatically updating a device that has intermittent network connectivity are described in this disclosure. The method includes receiving, at an electronic device from a server, a notification containing information about a promotion for at least one product, determining, based on the received notification, a change in the promotion for the at least one product, updating an action associated with the promotion based on the determined change in the promotion, and executing the updated action associated with the promotion without a network connection to the server.

### CROSS-REFERENCE TO RELATED APPLICATIONS AND CLAIM OF PRIORITY

This application claims priority under 35 U.S.C. § 119(e) to U.S. Provisional Patent Application Ser. No. 62/483,865, filed on Apr. 10, 2017, titled “SYSTEM AND METHOD FOR RETAIL DEMO PROMOTIONS.”

### TECHNICAL FIELD

This disclosure relates generally to remotely updating devices. More specifically, this disclosure relates to systems and methods for automatically updating a device that has intermittent network connectivity.

### BACKGROUND

In today's electronics retail environments, demonstration electronic devices are often installed to provide a demonstration of the device's capabilities. A single manufacturer may install a number of different demonstration devices at a given point of sale. However, the manufacturer of the demonstration devices may not have control of the devices when they have reached the point of sale.

### SUMMARY

Embodiments of the present disclosure provide systems and methods for automatically updating a device that has intermittent network connectivity.

In one embodiment, a method comprises receiving, at an electronic device from a server, a notification containing information about a promotion for at least one product, determining, based on the received notification, a change in the promotion for the at least one product, updating an action associated with the promotion based on the determined change in the promotion, and executing the updated action associated with the promotion without a network connection to the server.

In another embodiment, an electronic device includes a communication interface configured to communicate with a server via a network connection. The device further includes a processor configured to control the communication interface to receive, at the electronic device from the server, a notification containing information about a promotion for at least one product, determine, based on the received notification, a change in the promotion for the at least one product, update an action associated with the promotion based on the determined change in the promotion, and execute the updated action associated with the promotion without a network connection to the server.

In yet another embodiment, a non-transitory computer readable medium embodies a computer program, the computer program comprising computer readable program code that when executed causes at least one processing device to control a communication interface of an electronic device to receive, at the electronic device from a server, a notification containing information about a promotion for at least one product, determine, based on the received notification, a change in the promotion for the at least one product, update an action associated with the promotion based on the determined change in the promotion, and execute the updated action associated with the promotion without a network connection to the server.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system according to embodiments of this disclosure;

FIG. 2 illustrates an example graphical user interface (GUI) displaying contents of a promotional campaign that is administered by an electronic device on a screen of the electronic device;

FIG. 3 illustrates an example of a workflow for creation and delivery of a notification to an electronic device;

FIG. 4 illustrates an example sequence diagram showing creation and transmission of notifications to an electronic device;

FIG. 5 illustrates another example sequence diagram showing creation and transmission of notifications to an electronic device;

FIG. 6 illustrates yet another example sequence diagram showing creation and transmission of notifications to an electronic device;

FIG. 7 illustrates an example timing diagram of implementation of a promotional advertising campaign by a demonstration electronic device; and

FIG. 8 illustrates a flowchart of an example method for automatically updating a device that has intermittent network connectivity.

FIGS. 9-12 illustrate example screens of a GUI for designing a promotional advertising campaign for a demonstration electronic device.

### DETAILED DESCRIPTION

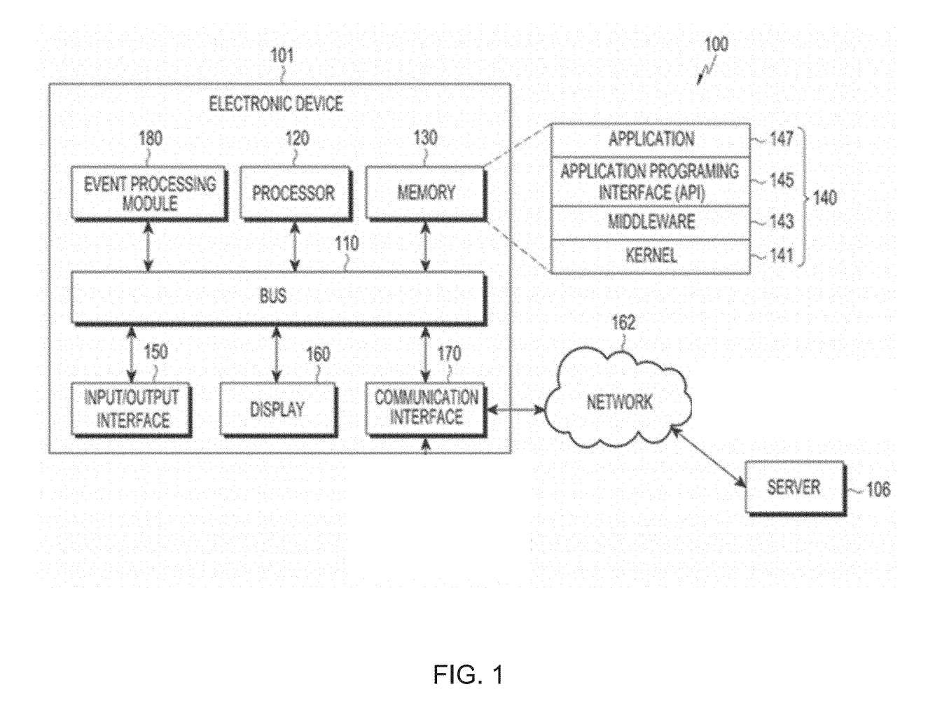

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure relate to systems and methods for transmitting content from a server to a remote electronic device, in particular in scenarios where the owner, manufacturer, or manager of the device does not have direct access to the device and cannot guarantee that it will have network connectivity to the server. This scenario commonly arises with demonstration devices in physical retail locations.

Even if the device is internet capable, the manufacturer, owner, or manager of the device does not have direct control over the device or over the network of the retail location and cannot rely on the device having a network connection. Often, such retail environments have tens or hundreds of internet-capable devices on display, and they do not have an interest in maintaining a reliable wireless network connection to all of them. Accordingly, embodiments of the present disclosure contemplate systems and methods for maintaining up-to-date information on such demonstration devices.

One example of information that the device owner would like to maintain as up-to-date as possible is promotional information related to the device or to other devices that the device owner knows are on display at the same retail location. For example, if the device owner sells mobile phones, tablets, televisions, and refrigerators in one retail location, it is beneficial to use screen real estate on those devices to advertise not only the device itself, but also the other devices. One form of advertising employed in physical retail locations is limited time promotions providing discounts or other incentives for purchase. Internet-connected demonstration devices provide advantageous features for promotional advertising as compared to traditional retail advertising (for example, with the use of printed posters, placards, or the like displayed in the retail location) in part because the device owner may be able to transmit promotional advertisements to the device in real time. Other advantages over traditional print advertising include cost savings on printing, logistics, and manpower involved in creating and distributing advertisements to retail locations.

There may be advantages to advertising a promotion on a demonstration device without indicating a start and end date of the promotion. For example, this allows real-time decision-making regarding the end date of the promotion. However, advertising a promotion without an end date carries a risk that a customer will see the advertisement after the end date and request that the promotion be honored. This may happen, for example, if a promotional advertisement is displayed on a screen of a demonstration device without an end date, and the demonstration device is not updated to reflect that the promotion has ended. In turn, the promotional advertisement could unintentionally be displayed past the end date if the promotional device relies on a network connection (e.g., an internet connection) for updates of the status of the promotion, but is not able to access a network before the promotion ends.

Embodiments of the present disclosure contemplate that a promotions manager may design a promotion and load the promotion on a server for delivery to one or more demonstration devices in a retail location which are currently connected to a network that includes the server (such as the internet). The demonstration devices may be a diverse set of different devices that are capable of network communication and display of the promotional content. The delivery of promotional content may be limited to particular retail channels, such as retail locations of a particular retail company or retail locations within a particular geographic area, or even to a subset of locations within a particular retail location (e.g., a retail sub-channel).

Embodiments of the present disclosure further contemplate that demonstration devices include internal logic that allows the device to intelligently administer the promotional content with or without network connectivity. For example, the device may maintain a database or other memory structure that includes start and end times for one or more promotion campaigns. The devices contain logic that allows them to independently track when it is time to start or end a promotion, to load promotional material into a display interface in a manner specified by the promotions manager, and to delete the promotion at the specified end date of the promotion, regardless of network connectivity. This logic is, in some embodiments, contained in a bootstrap application that runs on demonstration devices.

The bootstrap application prepares the demonstration devices for demonstration purposes, monitors and records activities of users (e.g., potential customers), uploads and saves analytics data, and automatically restores the device to preset configuration settings any time a user changes configuration settings of the device. Preparing the demonstration devices for demonstration purposes includes customizing the look and feel of the UI for retail display at initiation of the device, initiating an idle video loop and automatically launching demonstration apps, such as a promotional campaign display app, installing content based on the carrier, model, retail channel, or retail sub-channel, auto-populating contacts, calendar, messaging, and browser apps, and turning on or off various system settings (e.g., gesture recognition, screen brightness, volume, etc.). Monitoring and recording user activities includes logging application usage history, logging wireless data usage history, and monitoring device compliance. Uploading and saving analytics data includes uploading analytics data and compliance information to a server, such as a content management server (CMS) or other analytics server, where the analytics data can be used to tailor content to be delivered to the demonstration device. Restoring the demonstration device includes periodic restoration to the initialized demonstration state (e.g., nightly, hourly, or the like).

The bootstrap application additionally includes tamper-proof features, for example preventing users from initiating a factory reset or from changing system settings, including time and date settings. In some embodiments, the user is able to change the time and date that is displayed on the phone, but the system time and date remain unchanged, and the displayed time and date are restored to match the system time and date after an idle period. Additionally, a login credential may be required in order to change the system settings. For example, the device may require a retail channel manager's login credential in order to modify the system settings or perform a factory reset.

A demonstration device uses a network connection to initially load a promotional campaign materials and schedule, at which point the bootstrap application (or a separate promotional application) of the device administers the promotional campaign from that point without network connectivity. Additionally, if internet connectivity does become available, the device may receive updates from the server that modify or add new promotional campaigns to the device. The bootstrap application is capable of updating an existing promotional campaign based on such content.

Referring now to FIG. 1, there is illustrated an example computing system 100 according to various embodiments of this disclosure. The embodiment of the computing system 100 shown in FIG. 1 is for illustration only. Other embodiments of the computing system 100 could be used without departing from the scope of this disclosure.

The system 100 includes an electronic device 101, which may include at least one of a bus 110, a processor 120, a memory 130, an input/output interface 150, a display 160, a communication interface 170, or an event processing module 180. In some embodiments, the electronic device 101 may exclude at least one of the components or may add another component. In some embodiments, the electronic device 101 is a mobile device such as a mobile phone. The electronic device 101 could also be a smart home appliance such as, for example, a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., SAMSUNG HOMESYNC, APPLE TV, or GOOGLE TV), a gaming console (XBOX, PLAYSTATION), an electronic dictionary, an electronic key, a camcorder, or an electronic picture frame. The electronic device 101 disclosed herein is not limited to the above-listed devices, and may include new electronic devices depending on the development of technology.

The bus 110 may include a circuit for connecting the components 120 to 180 with one another and transferring communications (e.g., control messages and/or data) between the components.

The processor 120 may include one or more of a central processing unit (CPU), an application processor (AP), or a communication processor (CP). The processor 120 may perform control on at least one of the other components of the electronic device 101, and/or perform an operation or data processing relating to communication. The processor 120 executes instructions that may be loaded into the memory 130. Example types of processors 120 include microprocessors, microcontrollers, digital signal processors, field programmable gate arrays, application specific integrated circuits, and discrete circuitry.

The memory 130 may include a volatile and/or non-volatile memory. For example, the memory 130 may store commands or data related to at least one other component of the electronic device 101. The memory 130 could include any suitable volatile or non-volatile storage devices, including one or more components or devices supporting longer-term storage of data, such as a read only memory, hard drive, Flash memory, or optical disc. According to certain embodiments of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS).

For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. A plurality of applications 147 may be provided. The middleware 143 may control work requests received from the applications 147, e.g., by allocation the priority of using the system resources of the electronic device 101 (e.g., the bus 110, the processor 120, or the memory 130) to at least one of the plurality of applications 134.

The API 145 is an interface allowing the application 147 to control functions provided from the kernel 141 or the middleware 143. For example, the API 133 may include at least one interface or function (e.g., a command) for filing control, window control, image processing or text control.

The input/output interface 150 may serve as an interface that may, e.g., transfer commands or data input from a user or other external devices to other component(s) of the electronic device 101. Further, the input/output interface 150 may output commands or data received from other component(s) of the electronic device 101 to the user or the other external device.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display various contents (e.g., text, images, videos, icons, or symbols) to the user. In some embodiments, the display 160 displays content of a promotional advertisement to the user. The display 160 may include a touchscreen and may receive, e.g., a touch, gesture, proximity or hovering input using an electronic pen or a body portion of the user.

For example, the communication interface 170 may set up communication between the electronic device 101 and an external electronic device such as a server 106. For example, the communication interface 170 may be connected with the network 162 through wireless or wired communication to communicate with the external electronic device. The communication interface 170 could include, for example, a wireless transceiver, a network interface card (NIC), or the like. The network 162 may include at least one of communication networks, e.g., a computer network (e.g., local area network (LAN) or wide area network (WAN)), Internet, or a telephone network.

The wireless communication may use at least one of, e.g., long term evolution (LTE), long term evolution-advanced (LTE-A), code division multiple access (CDMA), wideband code division multiple access (WCDMA), universal mobile telecommunication system (UMTS), wireless broadband (WiBro), or global system for mobile communication (GSM), as a cellular communication protocol. The wired connection may include at least one of universal serial bus (USB), high definition multimedia interface (HDMI), recommended standard 232 (RS-232), or plain old telephone service (POTS).

According to embodiments of the present disclosure, the server 106 may include a group of one or more servers. The server 106 may provide notifications to the electronic device 101, which could provide promotional advertising campaign material including start and end dates of promotions or updates to the contents or start or end dates of existing promotions. In some embodiments, the server 106 is a CMS.

The event processing module 180 may process at least part of information obtained from other elements (e.g., the processor 120, the memory 130, the input/output interface 150, or the communication interface 170) and may provide the same to the user in various manners.

For example, according to embodiments of the present invention, the event processing module 180 may process information related to an event, which is generated when a notification is received from the server 106. The event processing module 180 may process start and end dates of a promotional campaign contained in the notification, and may direct other components to properly register the start and end dates so that the device 101 can appropriately administer the promotional campaign.

Although in FIG. 1 the event processing module 180 is shown to be a module separate from the processor 120, at least a portion of the event processing module 180 may be included or implemented in the processor 120 or at least one other module, or the overall function of the event processing module 180 may be included or implemented in the processor 120 shown or another processor. The event processing module 180 may perform operations according to embodiments of the present invention in interoperation with at least one program 140 stored in the memory 130.

In certain embodiments, the electronic device 101 may include a trusted execution environment (TEE) implemented in hardware or software. An example of such TEEs can be TRUSTZONE by ARM.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

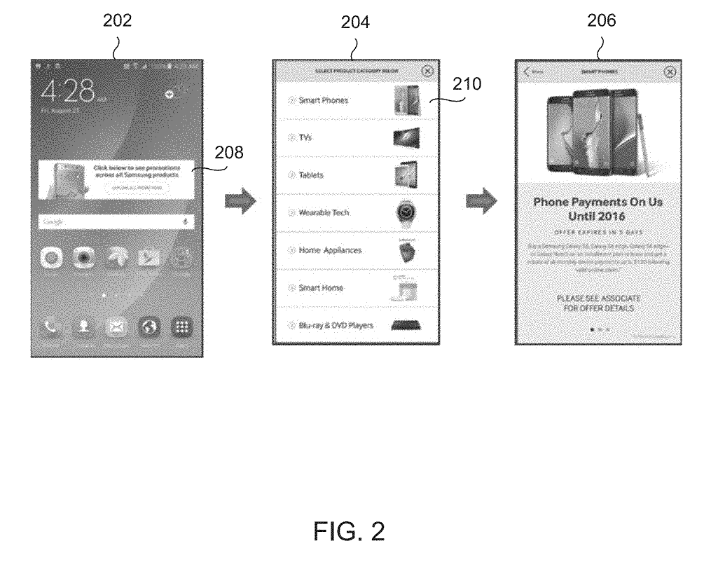

FIG. 2 illustrates an example graphical user interface (GUI) displaying contents of a promotional campaign that is administered by an electronic device 101 on a screen of the electronic device 101. In this embodiment, the electronic device 101 is a mobile phone, but it is understood that the promotional content may be adapted for displays of different electronic devices 101, such as TVs, smart refrigerators, or the like. In some embodiments, information necessary for adapting the content to display on different devices is included in a notification to the electronic device 101, and a promotion management application (which could be included in the bootstrap application) on the device determines how to display the content. In other embodiments, the notification targets each electronic device 101 specifically and includes only the content for proper display of the promotional campaign on that specific device.

FIG. 2 shows a progression of GUI configurations 202, 204, and 206 as a user of the electronic device 101 (for example, a customer at a retail location interacting with a demonstration device) moves deeper into nested menus of a promotional campaign provided via an application on the electronic device 101.

In GUI configuration 202, a home screen of a mobile device is displayed with a widget icon 208 that invites a user to tap the widget icon 208 to access promotional information for various products. The widget icon 208 could alternatively display information related to a specific promotion, such as a promotional price for the electronic device 101 that is displaying GUI configuration 202, a promotional price for another electronic device 101 that is in the same retail location as the electronic device 101, a promotional price for a service (such as a warranty) offered by the manufacturer, or the like. In some embodiments, the electronic device 101 prevents the widget 208 from being modified by a user that is trying functions of the device. In other embodiments, the electronic device 101 allows the widget 208 to be modified or deleted, but after a preset amount of time the electronic device 101 restores the widget 208 to its original state.

GUI configuration 204 may be displayed after a user taps on or otherwise actuates widget icon 208. In some embodiments, a function of the electronic device 101 that administers the promotional campaign could cause GUI configuration 204 to be periodically displayed while the demonstration electronic device 101 is idling. In GUI configuration 204, there may be displayed a list of categories 210 of electronic devices 101 for which promotions are available. This list could include only categories for which there exist devices that have a promotion currently running. In some embodiments, this could be a list of specific devices for which promotions are currently running.

GUI configuration 206 may be displayed after a user taps on or otherwise actuates one of the categories 210. In this embodiment, GUI configuration 206 displays a promotion for a specific device within the category 210 for “smart phones.” This could occur when only one device within the category 210 has a promotion currently available. In embodiments where multiple devices are available, a list of devices could be provided in GUI configuration 206, similar to the list of categories 210 in GUI configuration 204.

In some embodiments, a function of the electronic device 101 that administers the promotional campaign could cause GUI configuration 206 to be periodically displayed while the demonstration electronic device 101 is idling. If multiple devices at the same retail location have a promotion active, GUI configuration 206 could rotate displaying promotions for each of the devices.

Although FIG. 2 illustrates an example of GUI configurations of an electronic device 101, various changes may be made to FIG. 2. For example, various components in FIG. 2 omitted or additional components could be added according to particular needs. As a particular example, features of GUI configurations 204 and 206 could be displayed within the widget icon 208 without leaving the home screen of the electronic device 101.

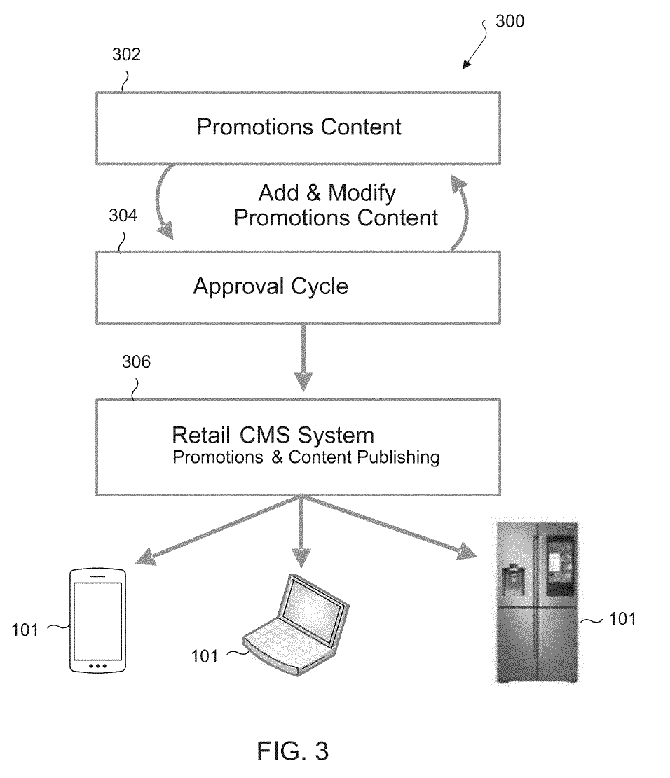

FIG. 3 illustrates an example of a workflow 300 for creation and delivery of a notification to an electronic device 101. At block 302, a promotions team creates content for a promotional campaign for one or more demonstrator electronic devices 101. In some embodiments, this content is prepared substantially the same as it will be displayed on a screen of the target electronic device 101. The created content is then passed on to an approval body (e.g., a promotions manager or an approval committee). In some embodiments, a web-based GUI is used to create and to review promotions content.

At block 304, the approval body reviews and either comments on, modifies, or approves a piece of promotional content. That is, the workflow may cycle between blocks 302 and 304 until promotional content is approved.

At block 306, once promotional content has been approved, the promotional content is transmitted to a server, such as server 106. In this embodiment, the server 106 is a content management server (CMS). The server 106 then functions to transmit the promotional content to applicable retail demonstrator electronic devices 101 that have a network connection to the server 106. For example, only a specific type of device (such as a mobile phone) may be scheduled to receive a given set of promotional content. In another example, only devices within a certain retail channel (e.g., a certain brand of retailer, or a certain geographic location) may be scheduled to receive a given set of promotional content. In other examples, only devices that are managed by a specific promotions account team may be scheduled to receive a given set of promotional content.

Although FIG. 3 illustrates an example of a workflow 300 for creation and delivery of a notification to an electronic device 101, various changes may be made to FIG. 3. For example, the notification may not be promotional content that is part of a promotional campaign, but may instead be an application that is only intended to be available to the demonstration device for a limited amount of time. As another example, the approval process may be internal to an account team rather than conducted by an approval body. Additionally, although the workflow 300 is described as creating and sending out promotional content, the workflow may also apply to updating existing promotional content.

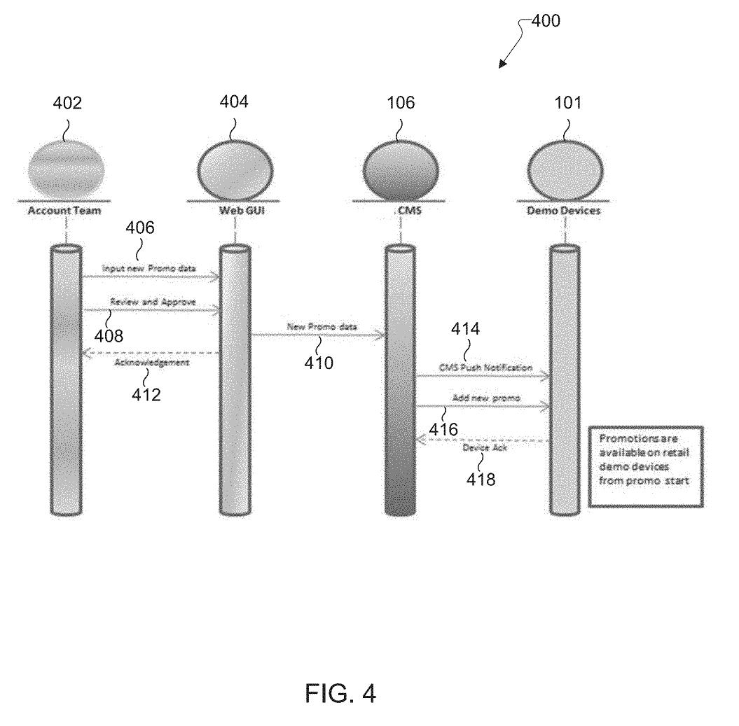

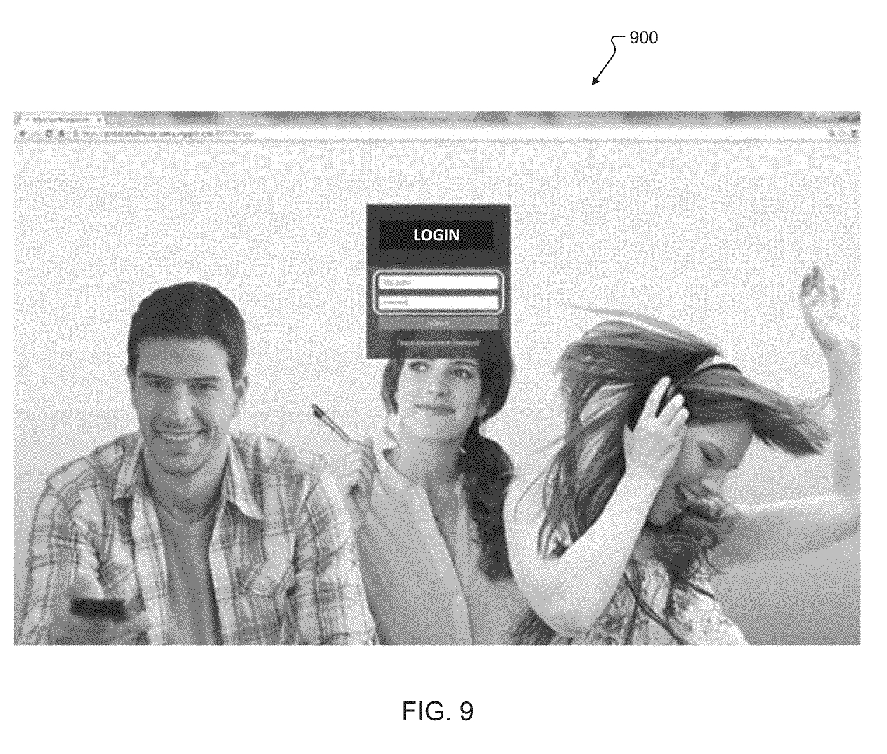

FIG. 4 illustrates an example sequence diagram 400 showing creation and transmission of notifications to an electronic device 101. In this embodiment, an account team 402 uses a web GUI 404 to create promotional content, as described above, and to transmit that content to a server 106 (which is a CMS in this embodiment). In the context of FIG. 4, reference will be made to FIGS. 9-12 to describe features of a web GUI of the sequence diagram 400.

The account team 402, at step 406, uses the web GUI 404 to design promotional content for a promotional advertising campaign, as described above. In this embodiment, review and approval of the promotional advertising campaign is handled internally within the account team 402. Accordingly, at step 408, the account team 402 interfaces with the web GUI 404 to conduct the review and approval process. For example, some members of account team 402 may design the campaign while other members of the account team 402 review and approve the campaign.

In some embodiments, FIG. 9 illustrates an example login screen 900 of an example web GUI 404. The login screen 900 functions both to provide security as well as to segregate account teams 402 by marketing channel. For example, each account team 402 is assigned to a particular marketing channel (e.g., a particular retail store brand, a particular geographical range, even a particular floor portion of a retail store location), and has a separate login credential that allows them to access promotional campaigns for their marketing channel. Additionally, managers of account teams 402 may have separate login credentials that allow them to review and approve campaigns.

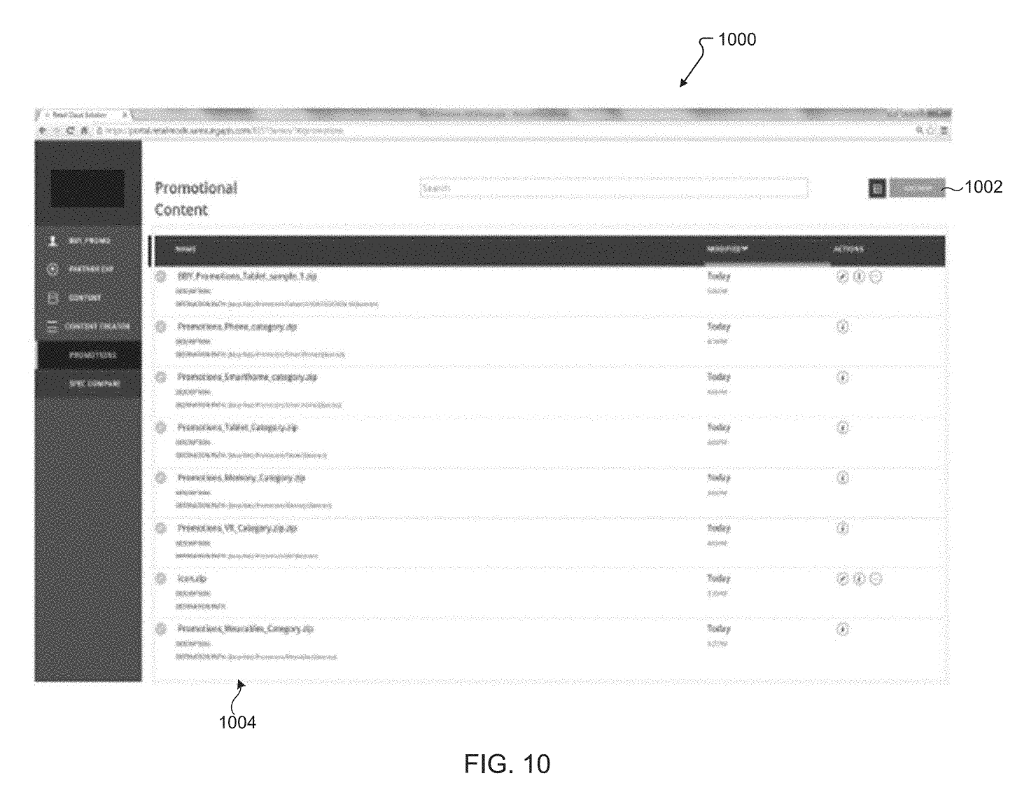

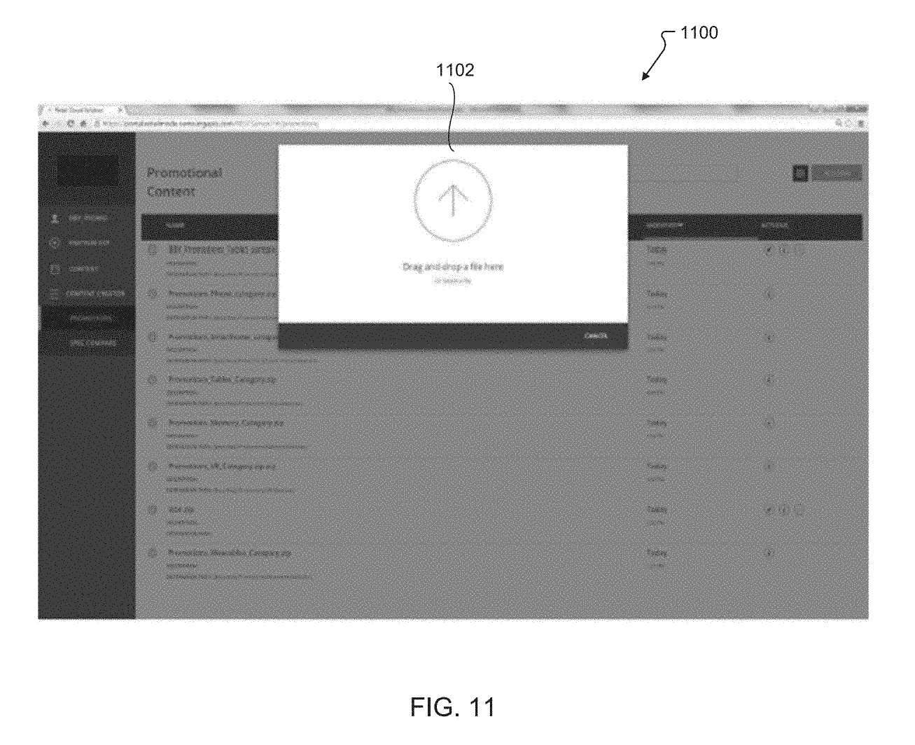

Following from FIG. 9, FIG. 10 illustrates an example content management screen 1000 of the example web GUI 404. The content management screen 1000 can be used to perform the steps 406 and 408 of FIG. 4. For example, the content management screen 1000 includes a button 1002 that can be used to add a new promotion to a list 1004 of active promotions. FIG. 11 illustrates an example content addition screen 1100 of the example web GUI 404. The content addition screen 1100 may have a drag-and-drop box 1102 for adding images, files, or the like to a campaign. The content addition screen 1100 could be used to add content to a new campaign after selecting the button 1002, or could be used to add content to an existing campaign after selecting a campaign from the list 1004.

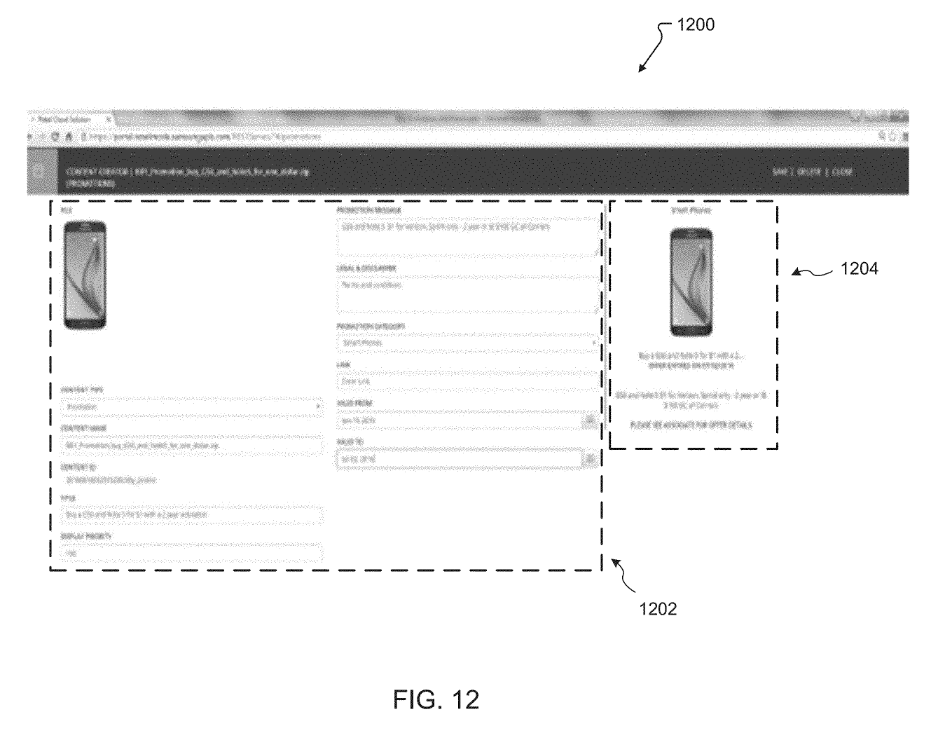

FIG. 12 illustrates an example promotional design screen 1200 of the example web GUI 404. The promotional design screen 1200 includes a design portion 2012 that allows for modification of media (e.g. images, audio, movies, animations, etc.) and text to be displayed on a demonstrator electronic device 101. The promotional design screen 1200 also includes a real time preview image 1204 that is an accurate illustration of the promotional content as it will be displayed on a selected demonstrator electronic device 101. In some embodiments, the real time preview image 1204 is interactive, and facilitates testing user inputs (e.g. tapping, scrolling, etc.) on the promotional campaign contents.

Returning to FIG. 4, once the promotional advertising campaign is finalized, the account team 402 notifies the web GUI 404 that it is approved (which may be included in the communications of step 408). The web GUI 404 next communicates with the server 106 at step 410 in order to load the promotional campaign onto the server 106 so that it may be transmitted to demonstrator electronic devices 101. Step 410 includes communicating information related to the promotional campaign, such as the promotional content and the start and end dates of the promotional campaign.

After sending the promotional campaign information to the server 106, the web GUI 404 sends an acknowledgement to the account team 402 at step 412 to inform the account team 402 that the promotional campaign has been transmitted to the server 106. In some embodiments, the acknowledgement is sent after receiving the promotional campaign but before uploading it to server 106 at step 410. In such embodiments, the acknowledgment merely acknowledges receipt of the promotional campaign by the web GUI 404.

The server 106 monitors intermittent network connectivity with target demonstration electronic devices 101. Ideally, employees of a retail location will, as a matter of policy, provide a network connection to the electronic devices 101 at least at a time of initial startup. After that point, the demonstration electronic devices 101 will attempt to connect to networks, such as a WIFI network of the retail location, whenever possible.

The server 106 at step 414 sends notifications to the target demonstration electronic devices 101 when a network connection is obtained. The notifications contain information that the target demonstration electronic devices 101 will use to implement the promotional campaign. This includes the promotional content that will be displayed, as illustrated in FIG. 2, as well as start and end dates for the promotion. In some embodiments the notifications sent at step 414 are push notifications, but it is understood that any suitable notification type may be used. At step 416, the server 106 indicates that the promotion in the notifications of step 414 is a new promotion. This information may be used by the target electronic devices 101 to determine that a new entry in a database of promotions should be entered. In some embodiments, this information is included in the notifications of step 414.

Upon receipt of the communications of steps 414 and 416, the demonstration electronic devices 101 will update an action associated with the promotional campaign. In this embodiment, because step 416 indicates that the notifications of step 414 contain information related to a new promotional campaign, the demonstration electronic devices 101 will enter content of the promotional campaign into, for example, a database of promotional campaign content. Additionally, the demonstration electronic devices 101 will enter start and end dates, if available, into a database of start and end dates for promotional campaigns.

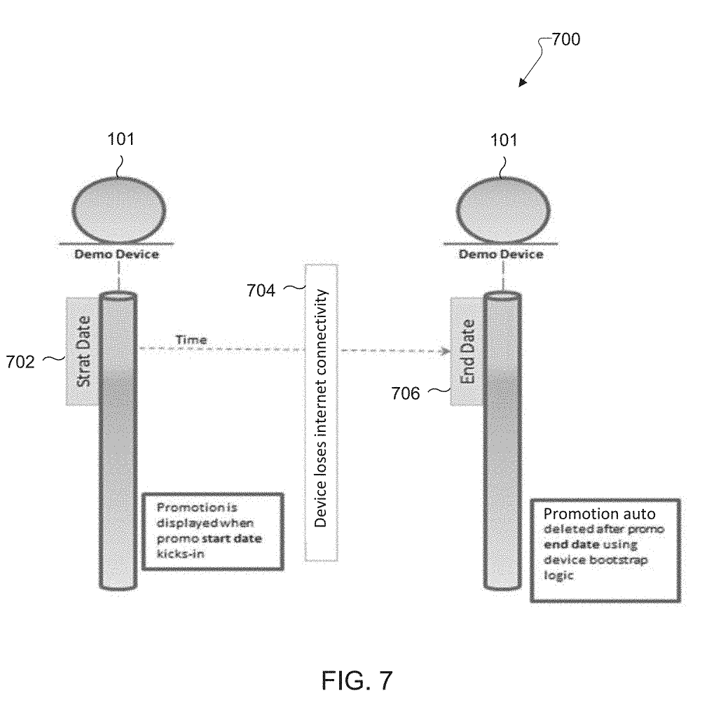

The target demonstration electronic devices 101 then send an acknowledgement (or ACK) back to the server 106 at step 418 to confirm receipt of the notifications of step 414. In some embodiments this is optional. The target demonstration electronic devices 101 will then proceed to administer the promotional campaign without further communication with the server 106 or the account team 402. This is described further below, with respect to FIG. 7.

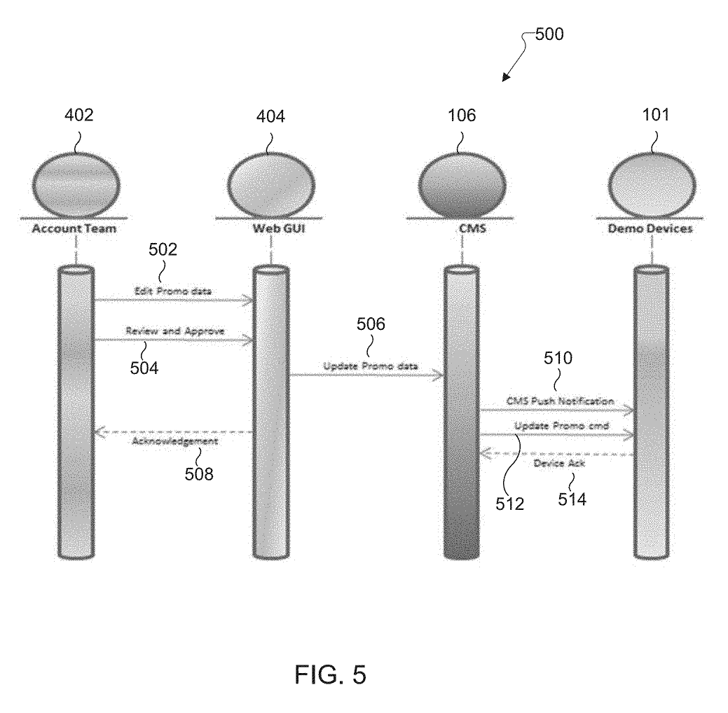

FIG. 5 illustrates an example sequence diagram 500 showing creation and transmission of notifications to an electronic device 101. In this embodiment, an account team 402 uses a web GUI 404 to update existing promotional content and to transmit that content to a server 106 (which is a CMS in this embodiment).

The account team 402, at step 502, uses the web GUI 404 to design updates or edits to promotional content for a promotional advertising campaign, such as the promotional campaign created in FIG. 4. Edits or updates could include, for example, changing the start or end date of the promotional campaign, changing an offer of the promotional campaign, changing the look of the images to be used to display the offer, or the like.

In this embodiment, review and approval of the promotional advertising campaign is handled internally within the account team 402. Accordingly, at step 504, the account team 402 interfaces with the web GUI 404 to conduct the review and approval process. For example, as described with respect to FIG. 4, some members of account team 402 may design the campaign while other members of the account team 402 review and approve the campaign.

Once the edits to the promotional advertising campaign are finalized, the account team 402 notifies the web GUI 404 that it is approved (which may be included in the communications of step 504). The web GUI 404 next communicates with the server 106 at step 506 in order to load the updates to the promotional campaign onto the server 106 so that they may be transmitted to demonstrator electronic devices 101. Step 506 includes communicating information related to the promotional campaign, such as any updates to the promotional content as well as updates to the start and end dates of the promotional campaign.

After sending the updates to the promotional campaign information to the server 106, the web GUI 404 sends an acknowledgement to the account team 402 at step 508 to inform them that the updates have been transmitted to the server 106. In some embodiments, the acknowledgement is sent after receiving the updates but before uploading them to server 106 at step 506. In such embodiments, the acknowledgment merely acknowledges receipt of the updates by the web GUI 404.

As discussed in FIG. 4, the server 106 monitors intermittent network connectivity with target demonstration electronic devices 101. As the demonstration electronic devices 101 are likely already set up in the retail location at this point, the devices will attempt to connect to networks, such as a WIFI network of the retail location, whenever possible. Upon making a connection with the server 106, they could inform the server 106 that they are available for communication.

The server 106 at step 510 sends notifications to the demonstration electronic devices 101 that are a target for the updated promotional content when a network connection is obtained. The notifications contain information that the target demonstration electronic devices 101 will use to update the promotional campaign. This could include updates to the promotional content that will be displayed as well as updates or changes to start and end dates for the promotion. In some embodiments the notifications sent at step 510 are push notifications, but it is understood that any suitable notification type may be used. At step 512, the server 106 indicates that the information in the notifications of step 510 is an update to an existing promotional campaign. For example, the communication of step 512 could include a unique identifier for a promotional campaign that is already loaded onto the target electronic devices 101. This information may be used by the target electronic devices 101 to determine that an update to an existing entry in a database of promotions should be entered. In some embodiments, this information is included in the notifications of step 510.

Upon receipt of the communications of steps 510 and 512, the demonstration electronic devices 101 will update an action associated with the promotional campaign. In this embodiment, because step 512 indicates that the notifications of step 510 contains information related to updates to an existing promotional campaign, the demonstration electronic devices 101 will replace, for example, content in a database of promotional campaign content with the updated content for the promotional campaign. Additionally, the demonstration electronic devices 101 will update start and end dates, if available, in a database of start and end dates for promotional campaigns.

The target demonstration electronic devices 101 then send an acknowledgement (or ACK) back to the server 106 at step 514 to confirm receipt of the notifications of step 510. In some embodiments this is optional. The target demonstration electronic devices 101 will then proceed to administer the promotional campaign without further communication with the server 106 or the account team 402. This is described further below, with respect to FIG. 7.

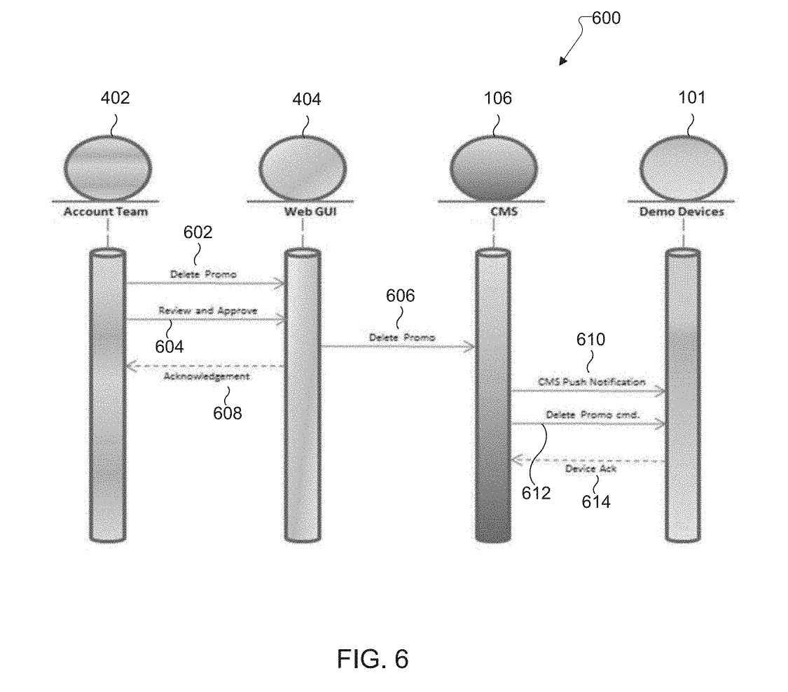

FIG. 6 illustrates an example sequence diagram 600 showing creation and transmission of notifications to an electronic device 101. In this embodiment, an account team 402 uses a web GUI 404 to implement deletion of a promotional campaign and to transmit a deletion instruction to a server 106 (which is a CMS in this embodiment).

The account team 402, at step 602, uses the web GUI 404 to implement deletion of a promotional advertising campaign, such as the promotional campaign created in FIG. 4. Such a deletion instruction may be part of a process, for example, for ensuring that a decision to delete a promotional campaign goes through a review process before it is transmitted to target demonstration electronic devices 101.

In this embodiment, review and approval of the deletion is handled internally within the account team 402. Accordingly, at step 604, the account team 402 interfaces with the web GUI 404 to conduct the review and approval process.

Once the deletion of the promotional advertising campaign is approved, the account team 402 notifies the web GUI 404 that it is approved (which may be included in the communications of step 604). The web GUI 404 next communicates with the server 106 at step 606 in order to load the deletion instruction for the promotional campaign onto the server 106 so that it may be transmitted to demonstrator electronic devices 101.

After sending the deletion instruction for the promotional campaign to the server 106, the web GUI 404 sends an acknowledgement to the account team 402 at step 608 to inform them that the updates have been transmitted to the server 106. In some embodiments, the acknowledgement is sent after receiving the updates but before uploading them to server 106 at step 606. In such embodiments, the acknowledgment merely acknowledges receipt of the updates by the web GUI 404.

As discussed in FIGS. 4 and 5, the server 106 monitors intermittent network connectivity with target demonstration electronic devices 101. As the demonstration electronic devices 101 are likely already set up in the retail location at this point, the devices will attempt to connect to networks, such as a WIFI network of the retail location, whenever possible. Upon making a connection with the server 106, they could inform the server 106 that they are available for communication.

The server 106 at step 610 sends notifications to the demonstration electronic devices 101 that are a target for deletion of the promotional campaign when a network connection is obtained. The notifications contain instructions to delete the promotional campaign. In some embodiments, the notifications may contain null data that effectively deletes the promotional campaign by overwriting it with nothing. In some embodiments the notifications sent at step 610 are push notifications, but it is understood that any suitable notification type may be used. At step 612, the server 106 indicates that the information in the notifications of step 610 is a deletion instruction for an existing promotional campaign. For example, the communication of step 612 could include a unique identifier for a promotional campaign that is already loaded onto the target electronic devices 101. In some embodiments, this information is included in the notifications of step 610.

Upon receipt of the communications of steps 610 and 612, the demonstration electronic devices 101 will update an action associated with the promotional campaign. In this embodiment, because step 612 indicates that the notifications of step 610 contain a deletion instruction for an existing promotional campaign, the demonstration electronic devices 101 will delete, for example, content in a database of promotional campaign content associated with the promotional campaign. Additionally, the demonstration electronic devices 101 will delete start and end dates, if available, in a database of start and end dates for promotional campaigns. In some embodiments, deletion may be accomplished by writing null data over the existing contents related to the promotional campaign. In other embodiments, deletion of the promotional campaign may be accomplished by setting the end date for the promotion to the current date, which will cause the demonstration electronic devices 101 to end the promotion as soon as the communications of steps 610 and 612 are received.

The target demonstration electronic devices 101 then send an acknowledgement (or ACK) back to the server 106 to confirm receipt of the notifications of step 610. In some embodiments this is optional. The target demonstration electronic devices 101 will then proceed to delete the promotional campaign without further communication with the server 106 or the account team 402. This is described further below, with respect to FIG. 7.

FIG. 7 illustrates an example timing diagram 700 of an implementation of a promotional advertising campaign by a demonstration electronic device 101. In this embodiment, the promotional advertising campaign has been received at the demonstration electronic device 101 from a CMS, such as server 106, as described above in FIGS. 4-6. It is understood that in other embodiments the promotional advertising campaign could be loaded on the demonstration electronic device 101 prior to its delivery to a retail location, it could be loaded on the demonstration electronic device 101 by an employee of the retail location, or it could be loaded by any other appropriate means.

The promotional advertising campaign has a start date 702 and an end date 706, which are stored in the demonstration electronic device 101. The start and end dates are set by an account team, such as account team 402, as described above with respect to FIG. 4. The demonstration electronic device 101 could maintain a database of start and end dates of multiple promotional advertising campaigns. The promotion management application (or bootstrap application) of the demonstration electronic device 101 tracks the date using a system clock of the demonstration electronic device 101 and compares to the start date of each promotional advertising campaign that it is responsible for administrating. In some embodiments, the demonstration electronic device 101 contains tamper-proof logic for tracking the date, so that customers of a retail location that adjust the date settings of the phone are not able to tamper with start and end dates of the promotional advertising campaign. For example, changing the system clock time of the demonstration electronic device 101 may require entry of security credentials that are assigned to an account team manager in control of the demonstration electronic device 101. When a start date 702 for a campaign is reached, the demonstration electronic device 101 adds content associated with the appropriate promotional advertising campaign to displayed promotional content, for example as shown above in FIG. 2.

In this embodiment, network connectivity (i.e., internet connectivity) is lost at a time 704 that is after the start date 702. As a result, the demonstration electronic device 101's connection with the server 106 is lost. In other embodiments, time 704 could be before start date 702. As described above, once a promotional advertising campaign is loaded onto the demonstration electronic device 101, the device does not need a network connection to administer the promotional advertising campaign. Accordingly, the demonstration electronic device 101 continues displaying the relevant content for the promotional advertising campaign uninterrupted after time 704.

The demonstration electronic device 101 continuously compares the present date, as determined by the tamper-proof system clock, with the end date 706 for each promotional advertising campaign that it is administering. When end date 706 arrives, the demonstration electronic device 101 removes content for the promotional advertising campaign from its display. In some embodiments, the demonstration electronic device 101 additionally deletes content related to the promotional advertising campaign from its memory. These actions are performed without network connectivity by the promotion management application of the demonstration electronic device 101.

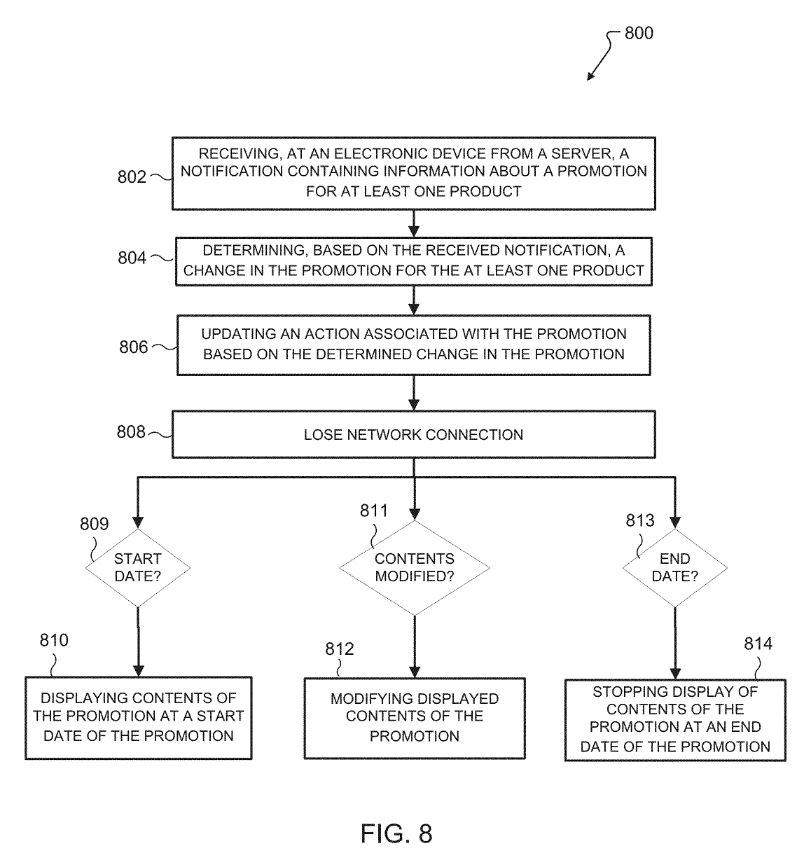

FIG. 8 illustrates a flowchart of an example method 800 for automatically updating a device that has intermittent network connectivity. In this embodiment, the method 800 is performed by a demonstration electronic device 101 communicating intermittently with a server 106, however, it is understood that the method 800 could be performed by any suitable device. Furthermore, updates performed in this embodiment are updates to a promotional advertising campaign, however, it is understood that any suitable device updates may be made according to this method. In this embodiment, the device is located in a retail location and the manager of the device does not have access to the device.

Beginning at block 802, the device receives, from a server 106, a notification containing information about a promotion for at least one product. In some embodiments, the product includes the device itself or another device that is available in the same retail location as the device. The notification could include information related to a change in a promotional advertising campaign. In some embodiments, the notification could include a full application to be installed and used by the device to administer the promotional advertising campaign. This application could perform the remaining functions of the method 800.

At block 804, the device determines, based on information in the received notification, a change to be made to a promotional advertising campaign administered by the device. For example, the device could determine from the notification that there is a change in a start or end date of the promotion, a change in an offer of the promotion, or an instruction to delete the promotion. Additionally, the notification could include an identifier associated with the promotional advertising campaign, allowing the device to administer multiple promotional advertising campaigns simultaneously.

At block 806, the device updates an action associated with a promotional advertising campaign. Updating an action associated with a promotional advertising campaign could include, for example, updating a display start time corresponding to the start date of the promotion, updating a display end time corresponding to the end date of the promotion, updating display contents corresponding to an offer of the promotion, or the like.

At block 808, the device loses network connectivity with the server 106. In other embodiments, this could occur any time after block 802. That is, the actions of blocks 804 and 806 can be performed without a network connection to the server 106. Blocks 810-814 represent different actions associated with the promotion that can be performed by the device. These actions are not mutually exclusive, and could be performed sequentially in some embodiments.

At decision block 809, the device checks its system date against the start date of the promotional advertising campaign. At block 810, if the start date of the campaign has arrived, the device displays contents of the promotional advertising campaign. In some embodiments, as described above, the notification of block 802 includes new contents for display, or a new start date for the promotion, which changes the implementation of block 810 by the device.

At decision block 811, the device checks whether the block 804 determined that the notification received at block 802 includes modifications to a promotional advertising campaign. At block 812, if modifications were received, the device modifies displayed contents of the promotional advertising campaign. For example, if the notification of block 802 includes a change to an offer of the promotional advertising campaign or a change to the display layout of the campaign, the device implements these changes in block 812.

At decision block 813, the device checks its system date against the end date of the promotional advertising campaign. At block 814, if the end date of the campaign has arrived, the device stops display of contents of the promotional advertising campaign. In some embodiments, as described above, the notification of block 802 includes a new end date, which affects implementation of block 814. In some embodiments, the notification of block 802 includes an instruction to delete the campaign, which will cause the device to stop displaying contents related to the campaign. In some embodiments, the device deletes information associated with the promotional advertising campaign when it stops displaying content related to the campaign.

Although FIG. 8 is an exemplary method 800 for updating a device that has intermittent network connectivity, various changes could be made to the method 800. As a specific example, a device could perform each of blocks 810, 812, and 814 in order without any communication with the server 106 beyond the initial notification of block 802.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method, comprising:
receiving, at an electronic device from a server, a notification containing information about a promotion for at least one product;
determining, based on the received notification, a change in the promotion for the at least one product;
updating an action associated with the promotion based on the determined change in the promotion; and
executing the updated action associated with the promotion without a network connection to the server.

2. The method of claim 1, wherein executing the updated action associated with the promotion includes displaying contents of the promotion at a start date of the promotion.

3. The method of claim 1, wherein executing the updated action associated with the promotion includes stopping display of contents of the promotion and deleting information associated with the promotion from the electronic device at an end date of the promotion.

4. The method of claim 1, wherein executing the updated action associated with the promotion includes modifying displayed contents of the promotion.

5. The method of claim 1, wherein the information about the promotion includes at least one of information related to a location of the electronic device or information related to a location of the at least one product.

6. The method of claim 1, wherein receiving the notification occurs at a setup time of the electronic device or when the electronic device obtains connection with the server.

7. The method of claim 1, wherein:
the change in the promotion includes at least one of:
a change in a start date of the promotion,
a change in an end date of the promotion, or
a change in an offer of the promotion, and
updating the action associated with the promotion includes updating at least one of:
a display start time corresponding to the start date of the promotion,
a display end time corresponding to the end date of the promotion, or
display contents corresponding to the offer of the promotion.

8. The method of claim 7, wherein:
updating the display start time corresponding to the start date of the promotion includes adding the display start time to a database of display times,
updating the display end time corresponding to the end date of the promotion includes adding the display end time to the database of display times, or
updating the display contents corresponding to the offer of the promotion includes adding the display contents to a database of display contents.

9. An electronic device, comprising:
a communication interface configured to communicate with a server via a network connection; and
a processor configured to:
control the communication interface to receive, at the electronic device from the server, a notification containing information about a promotion for at least one product;
determine, based on the received notification, a change in the promotion for the at least one product;
update an action associated with the promotion based on the determined change in the promotion; and
execute the updated action associated with the promotion without a network connection to the server.

10. The electronic device of claim 9, wherein the processor is further configured to execute the updated action associated with the promotion by displaying contents of the promotion at a start date of the promotion.

11. The electronic device of claim 9, wherein the processor is further configured to execute the updated action associated with the promotion by stopping display of contents of the promotion and deleting information associated with the promotion from the electronic device at an end date of the promotion.

12. The electronic device of claim 9, wherein the processor is further configured to execute the updated action associated with the promotion by modifying displayed contents of the promotion.

13. The electronic device of claim 9, wherein the information about the promotion includes at least one of information related to a location of the electronic device or information related to a location of the at least one product.

14. The electronic device of claim 9, wherein the processor is further configured to control the communication unit to receive the notification at a setup time of the electronic device or when the electronic device obtains connection with the server.

15. The electronic device of claim 9, wherein:
the change in the promotion includes at least one of:
a change in a start date of the promotion,
a change in an end date of the promotion, or
a change in an offer of the promotion, and
the processor is further configured to update the action associated with the promotion by updating at least one of:
a display start time corresponding to the start date of the promotion,
a display end time corresponding to the end date of the promotion, or
display contents corresponding to the offer of the promotion.

16. The electronic device of claim 15, wherein the processor is further configured to:
update the display start time corresponding to the start date of the promotion by adding the display start time to a database of display times,
update the display end time corresponding to the end date of the promotion by adding the display end time to the database of display times, or
update the display contents corresponding to the offer of the promotion by adding the display contents to a database of display contents.

17. A non-transitory computer readable medium embodying a computer program, the computer program comprising computer readable program code that when executed causes at least one processing device to:
control a communication interface of an electronic device to receive, at the electronic device from a server, a notification containing information about a promotion for at least one product;
determine, based on the received notification, a change in the promotion for the at least one product;
update an action associated with the promotion based on the determined change in the promotion; and
execute the updated action associated with the promotion without a network connection to the server.

18. The non-transitory computer readable medium of claim 17, wherein the computer readable program code further causes the at least one processing device to:
execute the updated action associated with the promotion by displaying contents of the promotion at a start date of the promotion.

19. The non-transitory computer readable medium of claim 17, wherein the computer readable program code further causes the at least one processing device to:
execute the updated action associated with the promotion by stopping display of contents of the promotion and deleting information associated with the promotion from the electronic device at an end date of the promotion.

20. The non-transitory computer readable medium of claim 17, wherein the computer readable program code further causes the at least one processing device to:
execute the updated action associated with the promotion by modifying displayed contents of the promotion.

21. The non-transitory computer readable medium of claim 17, wherein the information about the promotion includes at least one of information related to a location of the electronic device or information related to a location of the at least one product.

22. The non-transitory computer readable medium of claim 17, wherein the computer readable program code further causes the at least one processing device to:
control the communication unit to receive the notification at a setup time of the electronic device or when the electronic device obtains connection with the server.

23. The non-transitory computer readable medium of claim 17, wherein:
the change in the promotion includes at least one of:
a change in a start date of the promotion,
a change in an end date of the promotion, or
a change in an offer of the promotion, and
the computer readable program code further causes the at least one processing device to update the action associated with the promotion by updating at least one of:
a display start time corresponding to the start date of the promotion,
a display end time corresponding to the end date of the promotion, or
display contents corresponding to the offer of the promotion.

24. The non-transitory computer readable medium of claim 23, wherein the computer readable program code further causes the at least one processing device to:
update the display start time corresponding to the start date of the promotion by adding the display start time to a database of display times,
update the display end time corresponding to the end date of the promotion by adding the display end time to the database of display times, or
update the display contents corresponding to the offer of the promotion by adding the display contents to a database of display contents.
